(19) United States
(12) Patent Application Publication
(10) Pub. No.: US 2008/0003550 A1
(43) Pub. Date: Jan. 3, 2008

(54) Systems and method for recognizing meanings in sounds made by infants

(75) Inventor: Priscilla Dunstan, Bellevue Hill (AU)

Correspondence Address: FITZPATRICK CELLA HARPER & SCINTO, 30 ROCKEFELLER PLAZA, NEW YORK, NY, 10112, US

(73) Assignee: George Betsis, Point Piper (AU)

(21) Appl. No.: 11/477,487

(22) Filed: Jun. 30, 2006

(51) Int. Cl. G09B 19/00

(52) U.S. Cl. 434/156

(57) ABSTRACT

A method is provided for isolating and ascribing meaning to infant cry, and of teaching new parents and others how to attribute such meaning to particular cries correctly. In addition, an example of a system for use in teaching a person to do so stores, in reproducible audio form, at least one infant sound, or “word” (and preferably several such) from a group of predetermined infant words. A quick-reference presents information relating to the infant word(s) in visual form. Also provided is a teaching device that stores in reproducible audio form at least one infant word (and preferably a set of such words), and can play the infant word(s) back as audible sound. The storage may be a DVD, or an electronic memory containing audio files that can be accessed for playback by the playing means, which may be integral with the storage. One example of such an arrangement may be a chart or book with such memory and playback circuitry attached.

### BACKGROUND OF THE INVENTION

1. Field of the Invention

The present invention relates generally to recognition of the meaning of sounds made by infants, and more particularly to systems and methods for teaching or learning the ability to recognize such meanings.

2. Background

While the arrival of a new baby is an occasion of great joy, many parents can attest that caring for the infant frequently also involves frustration. Because the infant communicates wants by crying, it is up to the person caring for the child to determine what the baby needs at the moment, and to meet that need. Parents will tell you that what they most need and want to know is why their baby is crying and what they can do to resolve the baby's unhappiness.

As every new parent discovers, a newborn infant can sometimes spend hours crying every day and night. In fact, according to one authority, 20% of all babies are classified as “colicky babies”, which is defined as an infant crying for at least three hours per day, three days a week for three weeks (Prof. B. Lester, author of Why Is My Baby Crying, New York, 2005). Persistent crying is a major cause of distress for new parents.

Even with a baby who is not colicky, persistent crying challenges the parents with the feeling that the child is suffering some distress or some want that is not being remedied, and all new mothers (and fathers) have experienced sleepless nights attending to and desperately trying to pacify their crying, often screaming, babies. Parents of newborns can often wander around half-dazed with exhaustion and sleep deprivation, confused about what the problem might be and desperately trying to put an end to their infant's distress. To this must be added the common feeling experienced by the parents that they are failing in their duty, are incompetent, and in fact are proving unable to do what (they all too often imagine) all other normal adults can do perfectly well.

Research on infant crying has demonstrated associations between characteristics of the crying, and medical or neurological implications. Specifically, studies have shown associations between crying characteristics such as latency, duration, variability in fundamental frequency and amplitude, and neurobiological risk indices (Blinick, Travolga, & Antopoc, 1971; Corwin, Golub, & Potter, 1987; Corwin, Lester, & Golub, 1996; Corwin, Lester, Sepkoski, et al., 1992; Huntington, Hans, & Zeskind, 1990; Lester, Corwin, Sepkoski, et al., 1991; Lester & Dreher, 1989; Nugent, Lester, Greene, et al., 1996; Zeskind & Lester, 1981). Furthermore, research has demonstrated relations between an infant's crying characteristics and child outcome (i.e., neurological impairment and death) in infants affected by risk factors such as asphyxia, brain damage, Down's syndrome and other genetic anomalies (Fisichelli, Coxe, & Rosenfeld, 1966; Fisichelli & Karellitz, 1980; Golub & Corwin, 1982; Karellitz & Fisichelli, 1962; Lind, Vuorenski, Rosberg, et al., 1970; Michelsson, 1971; Michelsson, Sirviö, & Wasz-Höckert, 1977a,b; Ostwald, Peltzrnan, Greenberg, et al., 1970). The data suggest that the nature of a particular infant's cry is an indicator of biological and neurological risk.

From this point of view, there are two key aspects of crying: (1) the cry itself, which is innervated by the cranial nerves modulating the autonomic nervous system and signals emergency status; and (2) the salience of the cry to any potential caretakers in the environment, producing a visceral reaction that compels action (LaGasse, 2005). (Incidentally, the technical term “cry” and the more colloquial “crying” will both be used herein, and should unless otherwise specifically indicated be taken as synonyms.) The Biosocial Model of Infant Cry (BMIC) suggests that infant cry may also be used as an indicator of specific developmental processes (Lester, 1984a). Specifically, the BMIC identifies two distinct pathways from infant cry to outcome: (1) a Direct Pathway and (2) an Indirect Pathway (Lester, 1984a; Lester & Boukydis, 1992). The Direct Pathway suggests that infant cry reflects neurobiological status, which contributes directly to child outcome. The Indirect Pathway suggests that infant cry acts as a social signal that affects the caregiver; the caregiver, in turn, influences the child outcome. In other words, infant cry also contributes to child outcome by modifying care-giving responses to the infant. Research in the area of cry perception suggests that such a pathway exists. Specifically, previous research has shown that cry acoustics influence listeners' perception of cry as aversive, sick, urgent, distressing or arousing (Adachi, Murai, Okada, & Nihei, 1985; Gustafson & Green, 1989; Okada, Murai, & Adachi, 1987; Protopapas & Eimas, 1997; Schuetze, Zeskind, & Eiden, 2003; Schuetze & Zeskind, 2001; Zeskind & Lester 1978; Zeskind & Marshall 1988). Furthermore, listeners' ratings of cry samples along these dimensions are associated with their own reports of likelihood to provide and type of caregiving (Leger, Merrit, Thompson, et al., 1996; Gustafson & Green, 1989; Wood & Gustafson, 2001; Zeskind, Klein, & Marshall, 1992). However, there are no studies that have related cry acoustics to observed caregiver behaviour or the care-giving environment. The closest study to examine this was conducted by Lester and colleagues (Lester, Boukydis & Garcia-Coll, 1995). They found that infants of mothers who more accurately identified their infant's cry as aversive or as not aversive (based on the fundamental frequency of cry) had higher cognitive and language scores at 18 months than infants whose mothers misperceived their infant's cry signal. The authors hypothesized that care-giving behaviour moderated the association between the “goodness of fit” of infant cry and maternal perception with outcome.

Until recently, communication was thought of as consisting mostly of language, and since infants do not talk, they were considered incapable of communication (Lester 1984). However, infant crying contains linguistically salient aspects of human speech that are physiologically based and adapted for communication. Human speech is divided into linguistic and paralinguistic or suprasegmental aspects. The linguistic or lexical components refer to the elements, which develop meaning, as phonemes become syllables and words to be organized into phrases and sentences by rules of syntax. Qualitative aspects of speech, the intonation patterns, inflection, stress, intensity, and general melody form, constitute the paralinguistic component. These so called “prosodic” features of speech have their acoustical correlates in the timing (duration), amplitude (intensity) and fundamental frequency (dominant pitch) of phonation. It is these features that convey attitudes and emotional states. Communication relies heavily on these prosodic features of speech. They are the first aspects of language to appear in the vocal behaviour of the human infant, the cry. Thus, infant crying is part of the matrix for later language development (Lester, 1984).

Nonetheless, the foregoing observations, and the research underlying them, have not thus far led to any means by which a parent, or even a pediatrician or a specialist in linguistics, physiology or psychology, could reliably distinguish what an infant wants, from the sounds made by the infant in crying. It would be highly desirable to provide a way for new parents, and others tending to newborns and other infants, to determine accurately and easily the reason why their baby is crying. It also would be very desirable to be able to provide effective training in such a technique to new parents, and to others who may be involved in the care of infants.

### SUMMARY OF THE INVENTION

Accordingly, it is one object of the invention to provide such a technique to permit people, and in particular especially parents and other non-specialists, how to determine easily and reliably from the sounds an infant makes in crying, what the infant needs.

Another object of the invention is to provide an effective method for providing training in such technique.

Still another object is to provide such a training method that can be used by parents at home, or in a setting with an instructor.

Yet another object is to provide such a training method that provides training both in recognizing basic cries, that begin at birth, and in recognizing the meaning of other cries that begin as the infant becomes older.

According to one aspect of the invention, there is provided a method of teaching a person to ascribe meaning to an infant's or child's cry, by selecting from among a plurality of classes of cry that differ from each other in reflecting different needs of the infant or child. The person is presented with at least one sample of the cry that falls within a given one of the classes. After this has been done one or more times, the person is presented with plural samples of cry, and in response, gives an indication of which, if any, of the plural additional samples of cry fall within the given one of the classes. Feedback is then provided to the person as to the correctness of the indication. This method can be performed using materials and tools of greatly varying levels of technical sophistication, as described hereinbelow, ranging from simple face-to-face teaching, or self-teaching, using pre-recorded samples, written materials, etc., to interaction hardware or software devices. Teaching can be performed via the Internet, as well.

According to another aspect of the invention, there is provided a system for use in teaching a person to ascribe correct meanings to various crying produced by an infant, comprising means for storing in reproducible audio form at least one infant word (and preferably a set of such words), and a quick-reference means that presents information relating to the infant word(s) in visual form.

According to another aspect of the invention there is provided a teaching device for use in teaching a person to ascribe correct meanings to various crying produced by an infant, comprising means for storing in reproducible audio form at least one infant word (and preferably a set of such words), and means for playing back the infant word(s) as audible sound. The storage may for example be a DVD, and the player a standard DVD player, stand-alone or mounted in a computer, or the storage may be an electronic memory containing audio files that can be accessed for playback by the playing means, which may be integral with the storage. One example of such an arrangement may be a chart or book with such memory and playback circuitry attached.

These and other features and advantages of the present invention will be more clearly understood from the following detailed description of the preferred embodiments taken in conjunction with the accompanying drawings, in which like reference characters refer to like elements throughout.

### BRIEF DESCRIPTION OF THE FIGURES

FIG. 1 is an illustration of the use of one embodiment of the present invention.

FIG. 2 is an illustration of a second embodiment of the invention.

FIG. 3 is an illustration of a third embodiment of the invention (sound book).

FIG. 4 is a block diagram of circuitry used in the embodiment of FIG. 3.

FIG. 5 is a schematic illustration of a web-based embodiment of the invention.

FIGS. 6A and 6B are flowcharts illustrating a method of interpreting “words”, or of isolating “words”, within baby cry, according to the present invention.

FIG. 7 is a flowchart illustrating a method according to the invention, for teaching a person how to recognize and interpret such “words”.

### DETAILED DESCRIPTION OF THE PREFERRED EMBODIMENTS

The present invention represents an important departure from the previous work discussed above. As with previous work, it is based on the idea that there is meaning encoded in the infant's cry. However, instead of trying to identify that meaning from all the acoustical characteristics of the cry, the invention uses a system that ascribes meaning to particular sounds that can be thought of as a language of infant cry.

It is sometimes said that babies have different cries for different needs. For reasons explained in the following, however, the present invention is best understood not as differentiating between types of cries, but rather as extracting information, more particular sounds, contained within the cry, and ascribing meanings to those sounds. It has been found useful to think of this information or sound as a word within the cry. That is, using the present invention, one is no longer listening to the whole cry, but listening for the occurrence of a particular sound within a cry. It is believed that these sounds or words, and the differences among them, are the natural physical result of the tensions in various portions of the body that affect oral sounds, and that arise under the respective circumstances peculiar to each of these sounds.

That is, the inventor has devised a way to isolate or extract certain simple phonetic sounds infants produce (before they become distressed and “cry out”) and to which can be attributed specific meanings which forewarn of and become embedded in subsequent crying. Five of these phonetic sounds, for example, are signals for each of the five most common physical needs of all newborn babies. These “words” can in fact be very well thought of as an infant's unconscious “body-sound language”. Using the present invention, parents can easily learn to distinguish the different cries, how to attribute a meaning to each, and respond to their infant's needs faster and more accurately than ever before. Indeed, it has been found that as a result of parents understanding and responding to the baby cries, babies cry less and settle more quickly. Another important observed benefit is that parents experience a dramatic increase in confidence and bonding.

Thus far, the inventor has targeted about 30 such sounds to which one can ascribe or assign meanings. For purposes of illustration, the invention will be described with reference to five, which are essential sounds or words that correspond to five basic needs.

The first of these five sounds accompanies the sucking reflex. It is the sound “neh”. The second sound accompanies the reflex to release air trapped in the upper body, and is the sound “eh”. The third sound, “owh”, accompanies the reflex to yawn. The fourth sound accompanies the reflex to get rid of gas from the lower digestive system, and sounds like “eairh”, while the fifth accompanies the reflex to get rid of an irritation, and sounds like “heh”. The following explains these five sounds in more detail and describes the basis on which the inventor has ascribed to each a particular meaning.

Reflex is an involuntary movement of the body in response to a specific stimulus. When an infant vocalizes, sound is added to a reflex produced in the body creating a unique and specific sound. This sound pattern has characteristics that are produced only when the same reflex occurs in the body. Each reflex has its own signature sound that is reproduced only when the body is in a particular reflexive state and sound is added to it.

As already stated, the first of the basic words is “neh”. This sound is produced when a vocalization is added to the sucking reflex. It is an outward breath that fans over the palate and is shaped by the movement of the tongue.

Eh” is the second word, and relates to the reflex used by the body to expel air trapped in the upper airways—in plain language, a burp. The muscles tightening along the chest cavity make the sound. This causes a small inhalation followed by a slow, consistent and minimal release of air. The speed of exhalation is very slow so when the sound is added to it, it creates an elongated “eeeeeeeeeeeh” sound.

The third word is “owh”. This is a sudden inhalation followed by an open-mouth slow exhalation (a yawn). Sound is added on the exhalation (as is the case with most of the sound combinations).

“Eairh” is sound added to a constricted lower stomach. Instead of air traveling from the lower parts of the lungs it arrives from the top, and so comes on faster and more forcefully. The muscles and cramping occurring in the lower intestines create a very long, low but forceful exhalation.

“Heh” is vocalization added to a reflex connected to the skin. This reflex is a reaction to skin perspiration (as a result of the infant being at an uncomfortable temperature) and to irritated or itchy skin, which is felt as an immediate but temporary irritation (and not as a result of persistent conditions like eczema). In this reflex, sound travels in short pulses throughout the body as the reaction of the skin and underlying muscles produces a “heh, heh, heeeeeeh” sound pattern. This sound is all exhalation, starting fast and maintaining velocity whilst the body wriggles.

In summary, the opening of the vocal chords during a reflex produces specific sounds that can be classified into reoccurring patterns unique to each reflex. These patterns can be used to translate what the body needs or is doing into a phonetic audio language. This language is primal, involuntary and universal to the human species.

The sounds do not always come out clearly because the baby is not consciously trying to communicate. Rather, the sound is coming out as a result of a reflex and may be mixed with many other sounds as well. The significant sound may get buried amidst crying, especially if the baby has become distressed.

Again, the inventor has determined that the baby may make a combination of these sounds, as a result of several reflexes they are having at the same time. These are combination “words”—words which are created by two different sounds being made in sequence. These combination words can have ascribed to them a primary need and a secondary need. For example, the baby might be primarily tired but also a little hungry, or primarily uncomfortable with wind but also tired.

Experience has shown that the best way to learn the five basic words is to focus on the first three sounds initially, spending say at least a week concentrating on hearing only those sounds, and then going on to the next two sounds and spending at least a week with them. The reason for this is that the first three sounds are the easiest to differentiate between and are the most commonly occurring in helping the caregiver to settle the baby. If one can hear that one's baby is hungry or tired or has wind, and one takes action to satisfy those needs, the baby is likely to be settled.

Of all the sounds, probably the easiest sound to hear and to remember is “neh”, the sound ascribed by the inventor for hunger. “Eh” and “owh” are also usually understood clearly, especially at first, before the baby gets distressed. It has been found that many parents need longer to learn the second set of two words as they have similar phonetics to words in the first set, and may need to refer to their learning materials “on the go” until they have had a fair amount of practice listening to their own baby and to other babies.

It has been found useful, too, to test the meaning of the sounds. During one phase of research, the inventor spent time with mothers and their babies, listening to the babies' sounds and cries, asking the mother what she would usually do in this situation, and then offering the solution suggested by the sound. The mothers would often be surprised at the solutions suggested, and were very happy at how quickly the solutions worked.

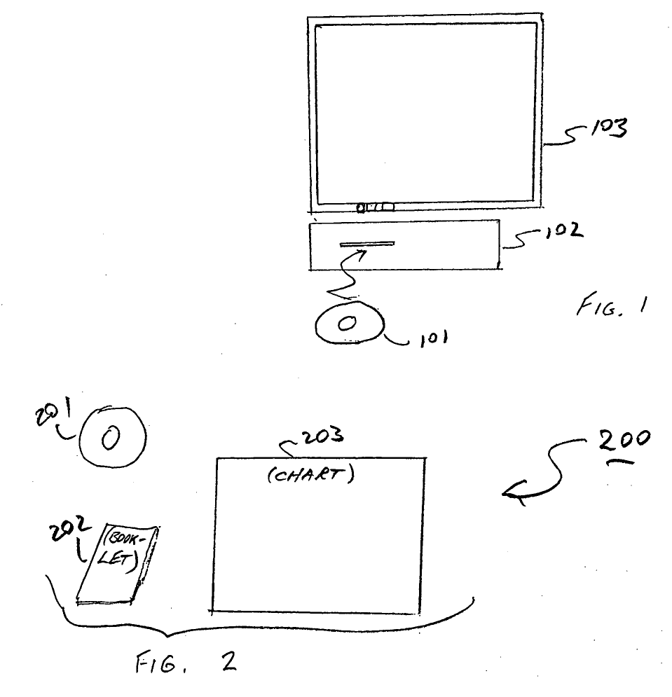

According to one preferred embodiment, the correct ascription of meaning to infant cries can be taught by means of a recording, such as a DVD 101, as shown in FIG. 1, being inserted into a DVD player 102 for display on a television screen or monitor 103. The DVD 101 of the embodiment of FIG. 1 includes oral explanation of the system of the invention (for example, generally along the lines of the foregoing, presented in a manner suitable for listening and understanding by the general public, rather than only by specialists). Also included in the recorded sound on the DVD are examples of each of the words being taught. Preferably, a considerable number of examples of each are provided, so that the listeners can get an idea of the great variability of cries in which the words may be embedded.

The DVD 101 may present the mentioned five basic sounds in five separate lessons, or present the first three (for example) in one lesson with one or two separate lessons for the fourth and fifth. Other organizations of the presentation are also possible and are within the scope of the invention.

Also, while it is technically simplest to produce a DVD that presents a video and an audio track to be watched and listened to by the audience, or even just an audio track, it is also within the scope of the invention to provide the DVD 101 with a degree of interactivity. For example, after presenting the first sound, the DVD 101 may offer the audience a series of samples of which some but not all contain that first word, and invite them to enter an indication of which ones they believe contain the sound being taught. Again, once two or more sounds have been presented, the audience may be given a series of samples among which they are to identify those containing each of the respective sounds. This arrangement can be implemented by making the DVD 101 compatible with one or another standard video-game interface (doing so of course is well within the ordinary level of skill in that art, and will not be described).

As shown in FIG. 2, another embodiment of the invention may be a kit 200 that includes a DVD 201 like that of FIG. 1, together with a book, booklet or other printed description 202 that may be a transcription of the audio track of the DVD 201, or may be a shorter summary. The booklet 202 may also include additional detail, reminders not to consider the invention as being in any way a substitute for expert medical care, or other information deemed helpful to the users. The printed description may instead be a book that presents a history of the development of the present invention, and if desired of other research of related interest. Other variations are also within the scope of the invention, and instead of a book or booklet, the mentioned historical, background and other text may be provided in some other format, such as on DVD 201 or a second DVD. Conversely, while the words are much easier to learn if one can listen to recorded examples, it should be considered as being within the broad scope of the invention to teach the sounds by means of a printed description (or even face to face without the use of recordings or other tools).

The kit of FIG. 2 is illustrated as also containing a quick-reference tool, which may be simply a chart 203 with a very brief description of the five words, their meaning, and the recommended response to each. The arrangement may be, by way of example, in three columns, for the word, the meaning and the response, and may include diagrams or photographs, or both, or text only. In a given instance, the kit may include only two of these three items, or may include additional components as well.

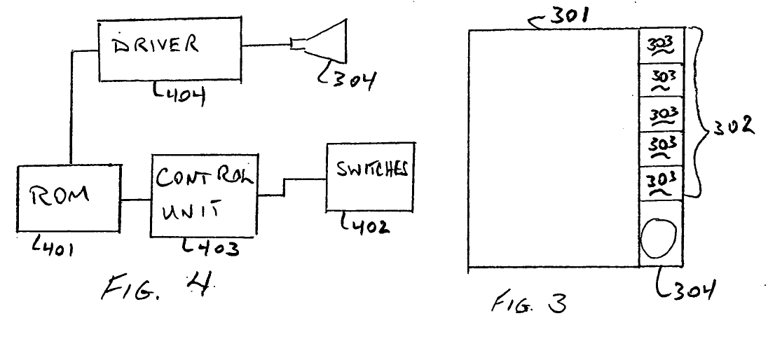

FIG. 3 illustrates another embodiment of the invention, which takes the form of a book 301 capable of electronically producing sounds on demand. Attached to one edge of the book's back cover is a panel 302 having (in this example) five rectangular areas 303 that serve as switches, as described below, and beneath them (toward the bottom edge of the book), a speaker 304. As shown in FIG. 4, the book contains circuitry, in any convenient form, including a ROM 401 that stores samples of each of the five words, preferably in digital form, although storage of analogue samples is also within the scope of the invention. Each of the five rectangular switch areas 303 overlies a pressure switch 402 (although the pressure switches are shown as a single block it will be understood that a pressure switch is provided for each of the rectangular areas 303) arranged so that pressing on one of the rectangular areas 303 causes the corresponding switch 402 to produce a signal that is received by a control unit 403 and understood as a demand for the output of a stored audio file that corresponds to the word to which the pressed area 303 corresponds. The control unit 403 accesses the appropriate audio file in the ROM 401 and causes the file to be read out and output to the speaker driver 404, for output as sound. If desired, the ROM 401 may store several samples of each word, so that the user is exposed to a variety of different babies producing cries that contain the same word and/or plural samples of the same baby producing cries that contain the same word. The selection among the several available audio files may be purely sequential, that is, the files are assigned a particular order and which one is accessed in a given instance is determined entirely by which was the last one to have been output. Alternatively, a pseudo-random generating technique may be used by the control unit 403 so that there is no discernible pattern in the selection. All these techniques are well within the ordinary level of skill in the relevant art(s), and therefore will not be described in further detail.

If desired, the book 301 shown in FIG. 3 may be a component of the kit 200 of FIG. 2, replacing, for example, the DVD 201.

Alternatively, the circuitry of FIG. 4 and the array of areas 303 and speaker 304 shown in FIG. 3 could be provided on a chart, such as that shown in FIG. 2, rather than a book. As another alternative, that circuitry and the switch array and speaker could be provided as a small hand-held unit that could be carried around by the parent, to permit the parent to listen to any of the sounds whenever time permits, or the audio files can be loaded onto a commercially available handheld or portable playback device, including by way of example, a CD player, a device or the type sold commercially under the iPod® trademark of Apple Computer, Inc., or the like.

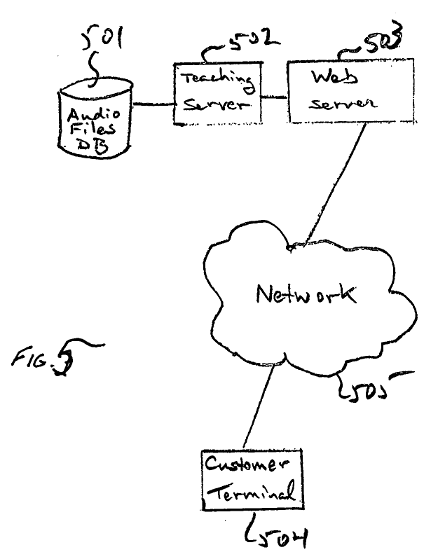

FIG. 5 shows schematically another approach within the scope of the invention, in which audio files containing the samples, etc., and oral explanation of the words, and the like, and preferably also one or more video files corresponding to at least the explanation, are stored in a database 501 controlled by a server 502. A customer who wishes to learn one or more of the words uses a terminal 504 to access a website run on a webserver 505, through which the customer is given access to the audio and video files. The audio and video files are presented to the customer in proper sequence under the control of server 502. Access to the website may be controlled by password authentication or other means, or the customer may be required to make payment to get access to a stated period of teaching, for example, one hour. These aspects of access control and payment can be implemented using well-known techniques.

Upon the customer obtaining access to the website and payment and authentication (if any) being tended to, the requested audio and video on the specific lesson (e.g., one word, or two or three words) are streamed to the customer's terminal 504 via the network 505. Alternatively, the audio and video files can be downloaded to the customer's terminal 504, in which case the files are preferably delivered in a format containing code to prevent unauthorized copying at or from the customer's terminal. The network 505 may be an Internet, or an intranet or other private network. For example, the network 505 may be a network within a hospital, so that the invention may be used by a new mother even before taking her baby home. The same network could be used by the hospital to instruct its staff using the invention.

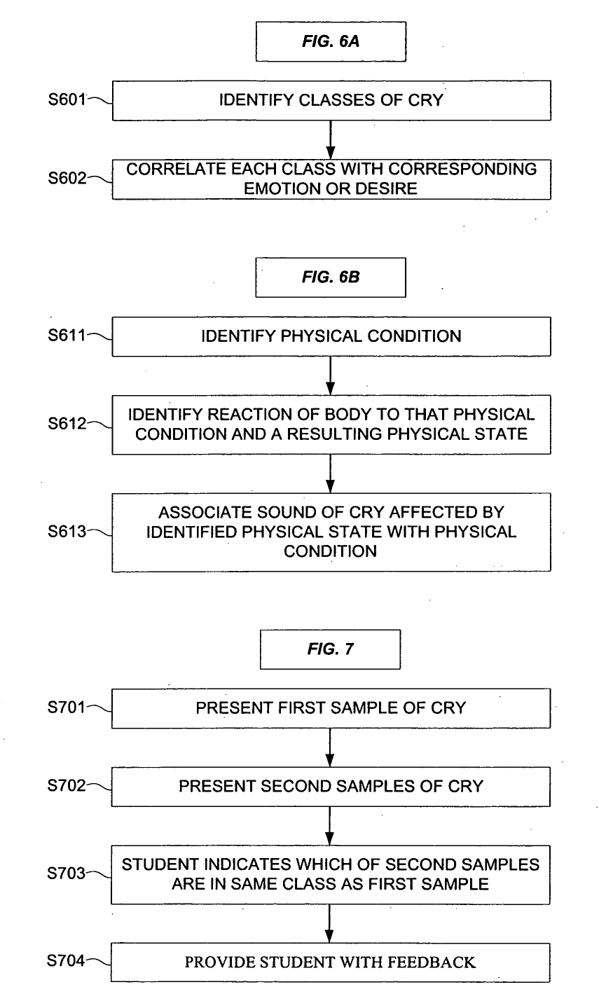

FIG. 6A is a flowchart illustrating a method of ascribing meaning to a child's or baby's cry. In step S601, two or more classes or cries or sounds are identified. Each such class corresponds to what in the foregoing is referred to as a single “word”, or unit of meaning. In step S602, correlations are made between each such class, and a respective corresponding emotion or desire of the baby or child. FIG. 6B is a flowchart illustrating similarly a method of isolating words in an infant's or a child's cry and ascribing meanings to the words. In step S611, a physical condition that causes discomfort (either physical or psychic) to the infant or child is identified. Then, in step S612, a reflexive or muscular reaction of the infant's or child's body to that physical condition, and a resulting physical state, are identified. The state of interest is one which will affect the quality or content of sound uttered by the child or infant during the existence of this state, as in the five examples discussed in detail above. Then, in step S613, a sound of the infant's or child's cry, affected by the existence of the identified physical state, is associated with the physical condition.

FIG. 7 is a flowchart illustrating a method according to the invention of teaching a person to ascribe a meaning to an infant's or a child's cry. In step S701, at least one sample of cry that falls within a particular class of cry is presented to the person. As described above, the “class” of cry corresponds to a particular meaning. This step may be performed once, but is preferably performed a number of times, to improve the person's opportunity to become well acquainted with the sample. Then, in step S702, the student is presented with plural samples of cry, which each may or may not belong to the same class as the sample(s) to which the person listened in step S701. In step S703, the student provides an indication as to which if any of the plural samples heard in step S702 fall within the class to which the sample(s) in step S701 belong. In step S704, the student is provided with feedback as to the correctness of the indication given in step S703.

The foregoing embodiments are described with reference to five “words”. As mentioned, however, the inventor has isolated and ascribed meaning to a rather larger number of “words”, and of course all of the words, or any group of them, could be included in any of these embodiments. Since the list of words actually used by a baby increases over time, as the infant grows and begins to interact in more and more complex ways with others, it is considered advantageous to present only the basic five at first, since the latter words only become relevant to specific developmental stages of the infant the learning task becomes less overwhelming. Instead of including all the words in one DVD, kit, etc., therefore, a number of separate presentations can be provided, containing different sets of “words”, so that a parent can learn just the words needed at a given time, and can go on to learn the next group when the infant's growth make the next group useful. It is within the scope of the invention, however, to provide materials for learning as many or as few of the words as desired, whether in the form of a book, booklet, DVD, audio cassette, other audio recording, chart, hand-held device, or other forms.

While the present invention has been particularly described with reference to what are at present the preferred embodiments, many variations and modifications will now be apparent to those skilled in the art. Accordingly, the scope of the invention is to be limited, not by the details of any of the foregoing embodiments, but only by the terms of the appended claims.

What is claimed is:

1. A teaching device for use in teaching a person to recognize meanings of various crying produced by an infant, comprising:
means for storing in reproducible audio form at least one infant word from a group of predetermined infant words; and
means for playing back as audible sound the infant word.

2. The device of claim 1, wherein said storing means can be inserted into and removed from said playing means.

3. The device of claim 2, wherein said storing means comprises a DVD and said playing means comprises means for playing back a DVD.

4. The device of claim 3, wherein said storing means stores the at least one infant word as an audio file, and said playing means includes means for accessing the audio file and playing back the audio file.

5. The device of claim 4, further comprising at least one sheet of material presenting visual information relating to the at least one infant word.

6. The device of claim 5, wherein the visual information includes at least one of text and an image.

7. A system for use in teaching a person to recognize meanings of various crying produced by an infant, comprising:
means for storing in reproducible audio form at least one infant word from a group of predetermined infant words and for playing the infant word back as audible sound; and
a quick-reference means that presents information relating to the at least one infant word in visual form.

8. The system of claim 7, wherein said quick-reference means comprises a chart providing visual information relating to each of plural infant words.

9. A method of interpreting children's/babies' cries and sounds, comprising the steps of:
identifying a plurality of classes of cries and sounds; and
correlating at least one respective emotion and/or desire with each of the classes of cries and sounds.

10. A method of isolating meanings of an infant's or child's cry, comprising the steps of:
identifying a physical condition causing discomfort to the infant or child;
identifying a reflexive or muscular reaction of the infant's or child's body to the physical condition, and a state of the infant's or child's body resulting from that reaction, that state being one that will affect a vocal nature of a vocal sound made by the infant or child during or immediately after the reflexive or muscular action; and
associating a sound of the infant's or child's cry with the physical condition.

11. A method of teaching a person to recognize a meaning of an infant's or child's cry, by selecting from among a plurality of classes of cry that differ from each other in reflecting different needs of the infant or child, said method comprising the steps of:
a) presenting to the person at least one sample of the cry that falls within a given one of the classes;
b) presenting to the person plural samples of cry;
c) eliciting from the person an indication of which, if any, of the plural samples of cry fall within the given one of the classes; and
d) providing the person with feedback as to the correctness of the indication.

12. A method according to claim 11, wherein said presenting step a) is performed using an audio recording of the at least one sample of the cry.

13. A method according to claim 12, wherein the audio recording is stored on a DVD and said presenting step a) is performed by playing back the audio recording.

14. A method according to claim 11, further comprising the step of e) providing the person with an explanation of at least one of the plural classes of cry preparatory to performing said steps a)-d).

15. A method according to claim 14, wherein the explanation is stored on a DVD and said providing step e) is performed by playing back the explanation from the DVD.

16. A method according to claim 14, wherein the DVD is interactive and wherein said eliciting step c) is performed by the DVD requesting the person to input the indication, and wherein said providing step d) is performed by a software module stored in the DVD comparing the indication input by the person with a correct answer and based on such comparison outputting the feedback for the person.

17. A method according to claim 12, wherein the audio recording is an audio file stored in a ROM and said presenting step b) is performed by playing back the audio file.

18. A method according to claim 17, wherein said eliciting step c) includes requesting that the person input the indication using an interface, and wherein said providing step d) is performed by means of a processor that compares the input indication with a correct answer and based on such comparison outputs the feedback for the person.

19. A method according to claim 11, wherein said presenting steps a) and b) are performed by playing back audio recordings via an Internet via a website that the person has accessed, said eliciting step c) is performed by a processor requesting the person's indication via the website, and said providing step d) is performed by providing the feedback to the person via the website.
